(19) United States
(12) Patent Application Publication
(10) Pub. No.: US 2025/0045706 A1
(43) Pub. Date: Feb. 6, 2025

(54) SYSTEM AND METHOD FOR MULTI DAY COMPUTERIZED TRADE

(71) Applicant: Nice Ltd., Ra'anana (IL)

(72) Inventors: Vaibhav CHOBE, Pune (IN); Kanchan VASNANI, Indore (IN); Jahid QURAISHI, Maharashtra (IN)

(73) Assignee: Nice Ltd., Ra'anana (IL)

(21) Appl. No.: 18/363,835

(22) Filed: Aug. 2, 2023

(51) Int. Cl. G06Q 10/1093; G06Q 10/0631

(52) U.S. Cl. CPC G06Q 10/1097; G06Q 10/063112

(57) ABSTRACT

Methods and systems for digital scheduling include, using a processor: identifying a set of target agents associated with a corresponding set of shift parameters that satisfy a set of preferences of a multi-day trade request initiated by a source agent; sending the multi-day trade request to a sub-set of the identified target agents selected by the source agent; and if a first target agent of the sub-set accepts the multi-day trade request, and if the multi-day trade request satisfies a pre-defined set of approval criteria, then automatically approving the multi-day trade request between the source agent and said first target agent, and automatically adjusting a schedule of the source agent and the first target agent to reflect the approved multi-day trade request; else: automatically rejecting the multi-day trade request.

### FIELD OF THE INVENTION

The present invention relates generally to systems and methods for digital scheduling.

### BACKGROUND OF THE INVENTION

Contemporary technology exists to handle one-off requests for changes to a digital schedule, such as changes to a schedule of an agent in a contact center due to unforeseen circumstances.

In such cases, the agents can take time off or trade their shifts. However, existing systems typically only allow agents to trade their shifts for a single day, which is inconvenient and inefficient if the required changes span multiple days.

Secondly, existing systems typically require agents to initiate, match, and submit requests to multiple target agents repeatedly for each day they want to trade their shift. This process is time-consuming and results in overhead.

Thirdly, existing systems typically require trade requests for each day to be individually accepted by the target agents and approved by the supervisor. This process can be complicated and slows down the shift trading process.

### SUMMARY

According to one or more embodiments, a computer implemented method for digital scheduling includes, using a processor: identifying a set of target agents associated with a corresponding set of shift parameters that satisfy a set of preferences of a multi-day trade request initiated by a source agent; sending the multi-day trade request to a sub-set of the identified target agents selected by the source agent; and if a first target agent of the sub-set accepts the multi-day trade request, and if the multi-day trade request satisfies a pre-defined set of approval criteria, then automatically approving the multi-day trade request between the source agent and said first target agent, and automatically adjusting a schedule of the source agent and the first target agent to reflect the approved multi-day trade request; else: automatically rejecting the multi-day trade request.

According to some embodiments, the set of preferences of the multi-day trade request includes at least one of: a date range preference, a time range preference, and a same-day trade preference.

According to some embodiments, one or more possible date values of the multi-day trade request are restricted upon initiation of the multi-day trade request based on an assessment of the schedule of the source agent against a set of validation criteria.

According to some embodiments, the validation criteria for a given date includes a check that: the source agent has a shift on the given date; a pending multi-day trade request does not include the given date; and the given date includes a shift with a tradeable activity.

According to some embodiments, the approval criteria includes: a check that a skill of the source agent matches a skill of the target agent, and a check that a scheduling unit of the source agent matches a scheduling unit of the target agent.

According to some embodiments, the multi-day trade request includes a single day with a shift trade request which overlaps with an existing shift of the source agent.

According to some embodiments, the multi-day trade request relates to two or more non-consecutive days.

According to some embodiments, the method includes, if the multi-day trade request accepted by the first target agent of the sub-set is automatically rejected due to not satisfying the pre-defined set of approval criteria, then automatically re-sending the multi-day trade request to the remaining target agents of the sub-set.

According to one or more embodiments, a method for scheduling, includes, using a computer processor: sending a shift trade request to a first agent, wherein the first agent is selected by a second agent from a list generated by the computer processor based on a set of shift trade request preferences submitted by the second agent; and automatically updating a schedule of the first agent and the second agent if: the shift trade request is accepted by the first agent; a skill of the first agent matches a skill of the second agent; and the first agent and second agent belong to a same scheduling unit; else: automatically rejecting the shift trade request.

According to some embodiments, the set of shift trade request preferences includes a shift day preference and a shift time preference.

According to some embodiments, the shift trade request includes a plurality of shift days.

According to some embodiments, if the shift trade request accepted by the first agent is automatically rejected due to a skill of the first agent not matching a skill of the second agent, or due to the first agent and second agent not belonging to the same scheduling unit, then the method includes automatically re-sending the shift trade request to one or more other agents on the list generated by the computer processor.

According to one or more embodiments, a system for digital scheduling includes: at least one processor; and a computer readable storage medium containing instructions which, when executed by the at least one processor, cause the at least one processor to: identify a set of target agents associated with a corresponding set of shift parameters that satisfy a set of preferences of a multi-day trade request initiated by a source agent; send the multi-day trade request to a sub-set of the identified target agents selected by the source agent; and wherein if a first target agent of the sub-set accepts the multi-day trade request, and if the multi-day trade request satisfies a pre-defined set of approval criteria, then automatically approve the multi-day trade request between the source agent and said first target agent of the sub-set to accept the multi-day trade request, and automatically adjust a schedule of the source agent and the first target agent to reflect the approved multi-day trade request; else: automatically reject the multi-day trade request.

According to some embodiments, the set of preferences of the multi-day trade request comprises at least one of: a date range preference, a time range preference, and a same-day trade preference.

According to some embodiments, the at least one processor is configured to restrict one or more possible date values of the multi-day trade request upon initiation of the multi-day trade request based on an assessment by the at least one processor of the schedule of the source agent against a set of validation criteria.

According to some embodiments, the validation criteria for a given date includes a check (e.g. by the at least one processor) that: the source agent has a shift on the given date; a pending multi-day trade request does not include the given date; and the given date includes a shift with a tradeable activity.

According to some embodiments, the approval criteria comprises: a check by the at least one processor that a skill of the source agent matches a skill of the target agent, and a check by the at least one processor that a scheduling unit of the source agent matches a scheduling unit of the target agent.

According to some embodiments, the multi-day trade request includes a single day with a shift trade request which overlaps with an existing shift of the source agent.

According to some embodiments, the multi-day trade request relates to two or more non-consecutive days.

According to some embodiments, the at least one processor is configured to, if the multi-day trade request accepted by the first target agent of the sub-set is automatically rejected due to not satisfying the pre-defined set of approval criteria, automatically re-send the multi-day trade request to the remaining target agents of the sub-set.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 is a flowchart of a method for digital scheduling, according to some embodiments of the invention;

FIGS. 3A and 3B schematically show how existing WFM components may be used by some embodiments of the invention;

FIGS. 4A, 4B, and 4C show example flows, according to some embodiments of the invention;

FIGS. 5A, 5B, and 5C show example results of simulations, according to some embodiments of the invention;

FIG. 6 shows an example user interface, according to some embodiments of the invention; and

FIG. 7 shows a flowchart of a method, according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to digital scheduling.

As used herein, “Call Center” may refer to a centralized office used for receiving or transmitting a large volume of enquiries by telephone. An inbound call center may be operated by a company (e.g. a tenant) to administer incoming product or service support or information enquiries from consumers.

As used herein, “Contact Center” may refer to a call center which handles other types of communications other than voice telephone calls, for example, email, message chat, SMS, etc. Reference to call center should be taken to be applicable to contact center.

As used herein, an “Agent” may be a contact center worker that answers incoming contacts, handles customer requests and so on.

As used herein, “Work Force Management (WFM)” may refer to an integrated set of processes that a company uses to optimize the productivity of its employees. WFM involves effectively forecasting staffing requirements and creating and managing staff schedules to accomplish a particular task on a day-to-day and hour-to-hour basis. Embodiments of the invention may be part of, integrated with, or otherwise interact with new and existing WFM technology and processes.

As used herein, “Staffing Requirements” may refer to the required amount of personnel (e.g. agents) needed at a contact center to handle expected/forecasted contacts in accordance with quality-of-service metrics. Embodiments of the invention may ensure that staffing requirements are met by, for example, only allowing shift trades where both agents have a common skill such that the required staffing for that skill is preserved for the time periods of the traded shifts.

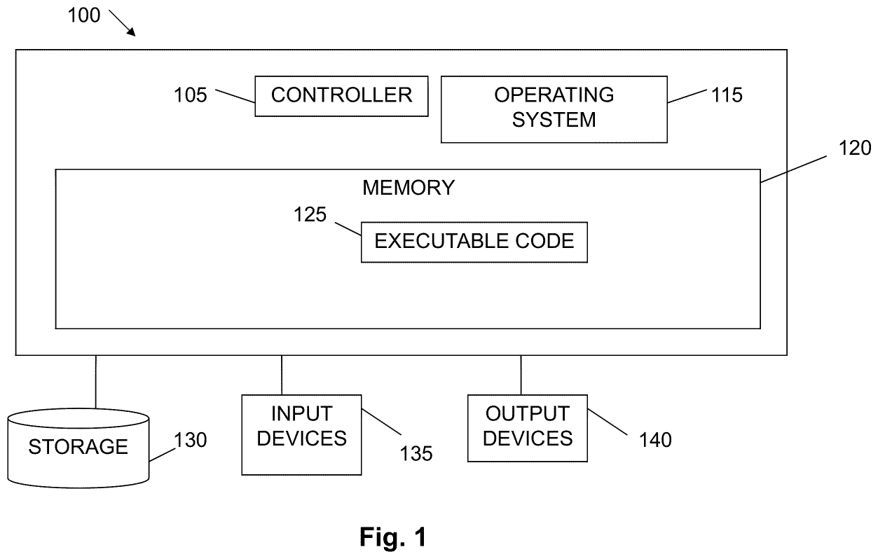

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out methods as disclosed herein, and/or data as disclosed herein such as agent data (e.g. skill data), schedule data (e.g. shift times, scheduled work days, scheduling unit), shift parameters, agent preferences, approval criteria, validation criteria, or any other type of data.

Executable code 125 may be any application, program, process, task, or script. Executable code 125 may be executed by controller 105 possibly under control of operating system 115. For example, executable code 125 may be or execute one or more applications performing methods as disclosed herein, such as for updating an assignment of resources. In some embodiments, more than one computing device 100 or components of device 100 may be used. One or more processor(s) 105 may be configured to carry out embodiments of the present invention by, for example, executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

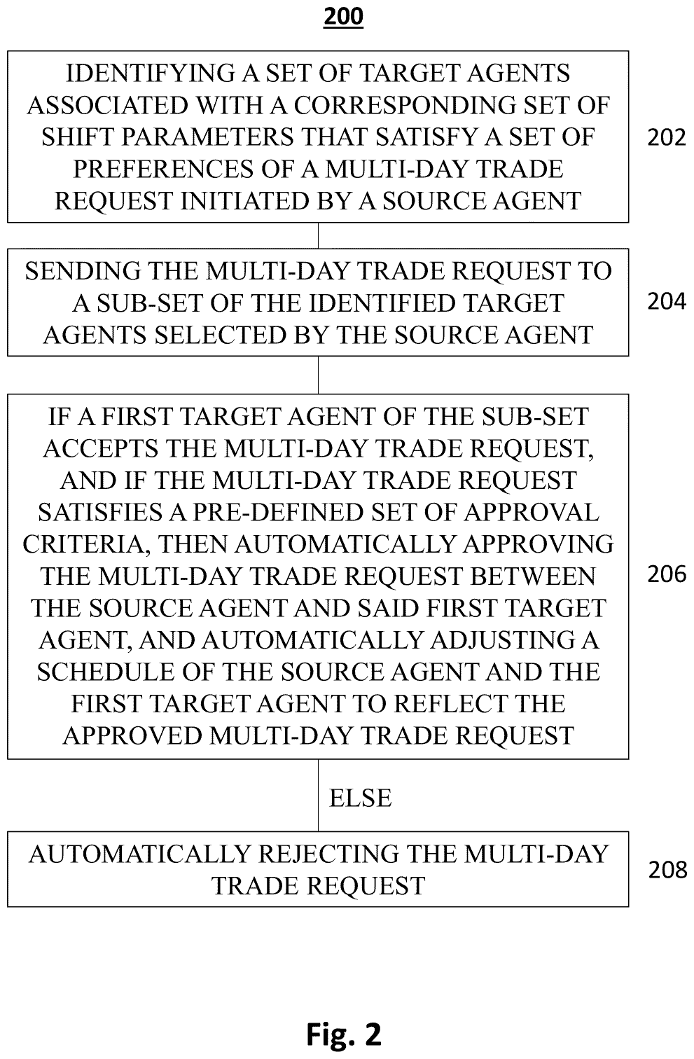

FIG. 2 shows a flowchart of a method 200 for digital scheduling, according to some embodiments of the invention. Method 200 may be a computer implemented method, for example one or more steps of method 200 may be carried out in part or in whole by a computer processor such as controller/processor 105 as shown in the computing device 100 of FIG. 1.

Method 200 may include identifying a set of target agents. For example, target agents may be searched for or identified as those agents associated with a corresponding set of shift parameters that satisfy a set of preferences of a multi-day trade request initiated by a source agent (Step 202), for example initiated using an agent terminal. An agent terminal may be a computing device, such as computing device 100 shown in FIG. 1. An agent terminal may be, for example, a personal computer, laptop, smartphone, digital tablet, or the like.

A target agent (e.g. one of a plurality of target agents included in the set of target agents) and a source agent may be referred to as such herein due to a multi-day trade request originating from the source agent and being targeted at a target agent. A multi-day trade request may represent a request from the source agent to trade a number of shifts (e.g. relating to multiple, possibly non-consecutive, days) with the target agent.

The set of shift parameters may correspond to the set of target agents in that each target agent of the set of target agents may be associated with a number of shift parameters (e.g. shift start time, shift end time, shift day, shift activity, required shift skill, or the like). Shift parameters for a target agent may be represented as an ordered list of values, an array, a tuple, a vector, or any other suitable data representation. The set of shift parameters may thus represent a set of such lists, arrays, tuples, or vectors corresponding in size (e.g. having the same cardinality) as the set of target agents. Identifying target agents may include identifying agents whose associated shift parameters match, or are within ranges defined by, shift trade preferences set by the source agent.

The set of preferences of the multi-day trade request may include at least one of: a date range preference, a time range preference, and/or a same-day trade preference. One or more preferences may be selected by the source agent at the time of placing the request.

An example of a date range preference may be a request to trade multiple shifts from 1^{st} January-4^{th} January for shifts in the range 8^{th} January-12^{th} January.

An example of a time range preference may be a request to trade multiple 9 AM-5 PM shifts for 12 PM-8 PM shifts.

An example of a same-day trade preference may be a request to trade a 9 AM-5 PM shift to a 12 PM-8 PM shift on the same day.

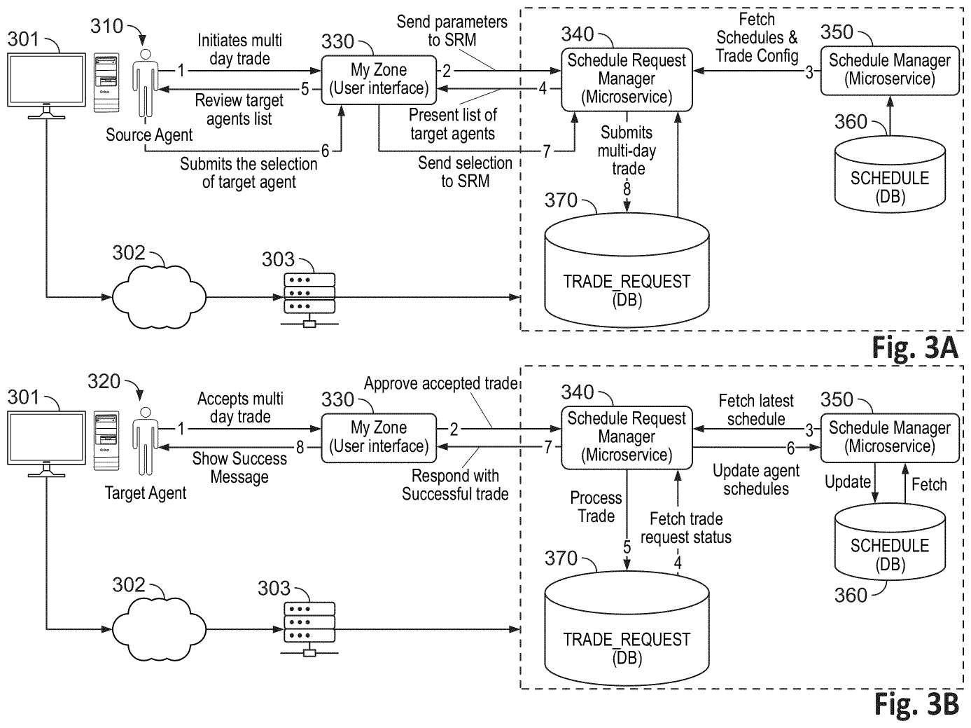

Method 200 may include sending or transmitting (e.g., via a network connecting agent terminals 301 shown in FIGS. 3A and 3B) the multi-day trade request to a sub-set of the identified target agents selected by the source agent (Step 204). For example, based on the multi-day trade request preferences, a set of 10 target agents may be identified with shift parameters that satisfy (e.g. match or correspond to a pre-defined level of deviation) the preferences. The source agent may select one or more of these example 10 target agents for whom the source agent believes the target agent will accept their trade request. For example, the source agent may select 6 of the 10 identified agents. These selected 6 target agents form a subset of the identified 10 target agents. The remaining 4 target agents will not receive the trade request, because they were not selected by the source agent. In some embodiments, if none of the selected 6 target agents accept the trade request, the remaining 4 target agents of the identified set of 10 target agents may be sent the trade request. These agents may receive the request automatically, or the source agent may be given the choice if they want to expand their initial selection if none of the originally selected agents accept the trade request. For example, if the multi-day trade request accepted by the first target agent of the sub-set is automatically rejected due to not satisfying the pre-defined set of approval criteria, then method 200 may include automatically re-sending the multi-day trade request to the remaining target agents of the sub-set.

Method 200 may include, if a first target agent of the sub-set accepts the multi-day trade request (e.g. by receiving input from the agent to an agent terminal 301 as shown in FIGS. 3A and 3B), and if the multi-day trade request satisfies a pre-defined set of approval criteria, then automatically approving the multi-day trade request between the source agent and said first target agent, and automatically adjusting a schedule of the source agent and the first target agent to reflect the approved multi-day trade request (Step 206). For example, method 200 may be based on a first-come, first-served basis such that the first target agent of the selected target agents to accept the request prevents other target agents of the selected sub-set from accepting the request. In some embodiments, an order of acceptance between the selected sub-set of target agents may be stored by the processor (such as in memory 120 and/or storage 130), such that if the trade request between the source agent and the target agent who was first to accept is rejected, then the trade request may be reopened for other target agents to accept, or the stored order may be used to automatically select the next target agent who was second to accept.

The approval criteria may include a check that a skill of the source agent matches a skill of the target agent, and/or a check that a scheduling unit of the source agent matches a scheduling unit of the target agent. Embodiments of the invention may compare data in a pre-defined data store of skills and scheduling units associated with agents as part of the approval criteria checking. The data store may be, for example, memory 120 and/or storage 130 as shown in FIG. 1.

Adjusting a schedule of each agent may include substituting the shifts of the source agent for the shifts of the target agent on the relevant days. The schedule may be an online accessible schedule, such as in a dashboard or user area of a web-based or downloadable application/app.

If no target agent of the sub-set accepts the multi-day trade request, or if the multi-day trade request does not satisfy the pre-defined set of approval criteria (e.g. an “ELSE” condition to Step 206) then method 200 may include automatically rejecting the multi-day trade request (Step 208). The source agent and/or the target agent may be automatically notified of the rejection (e.g. by email, short message service (SMS), in-system message, or the like).

In some embodiments, one or more possible date values of the multi-day trade request are restricted upon initiation of the multi-day trade request based on an assessment of the schedule of the source agent against a set of validation criteria. For example, a source agent may be prevented from selecting a particular date as part of the request if the source agent does not have a shift on that date; the date may appear “greyed-out” in a drop-down calendar and may not be selectable.

The validation criteria for a given date may include a check that, for example: the source agent has a shift on the given date; a pending multi-day trade request does not include the given date; and/or the given date includes a shift with a tradeable activity. Embodiments of the invention may therefore prevent (e.g. by the “grey-out” restriction discussed herein) several different multi-day trade requests being made in respect of the same dates, thereby reducing the number of trade requests in the scheduling system and reducing processing time in handling such redundant requests.

Whether a shift includes a tradeable activity may be determined by, for example, checking a pre-defined data store of activity types and a tradeable yes/no status (e.g. a Boolean value). The data store may be, for example, memory 120 and/or storage 130 as shown in FIG. 1.

In some embodiments, the multi-day trade request includes a single day with a shift trade request which overlaps with an existing shift of the source agent. Such a request may still be referred to as a multi-day trade request in spite of only including a single day. For example, embodiments of the invention may process an example trade request submitted in respect of trading a 9 AM-5 PM shift for a 12 PM-8 PM shift on the same day, since such shifts overlap (e.g. the 12 PM start is included in the original range 9 AM-5 PM).

Embodiments of the invention may process multi-day trade requests which relate to two or more non-consecutive days. For example, shifts on Monday, Wednesday, and Friday of one week may be requested to be traded for shifts (possibly of different time ranges) on Tuesday, Thursday, and Saturday (possibly of the same or a different week).

Embodiments of the invention may be integrated with, and may influence, existing processes and architecture components of existing WFM applications. For example, embodiments of the invention may affect and improve, technology such as a Schedule Requests Manager microservice (MS) and/or a Schedule manager microservice. A Schedule Requests Manager allows agents to request changes to their own schedules by using Shift Trade, and to allow processing of Trade requests for Auto approval. These requests include any activity which is marked as tradable in the Schedule Manager trade configuration. A Schedule Manager may be a core application in a scheduling system. The Schedule Manager may be responsible for storing and retrieving schedule data, net staffing data, and all configurations required to generate schedules including daily rules, weekly rules, and activity codes, and stores the shift trade configuration of the system.

FIGS. 3A and 3B schematically show how existing WFM components may be used by embodiments of the invention.

In FIG. 3A, a source agent 310 initiates a multi-day trade request using a user interface 330 such as the My Zone system developed by NICE LTD., or an Employee Engagement Manager “EEM” application (app) which may be an interface for agents to view their schedule, perform shift trades, request time off, and the like. User interface 330 may be presented by an agent terminal 301 (e.g. a computing device as shown in FIG. 1). User interface 330 may send parameters (such as a set of preferences of the multi-day trade request initiated by source agent 310 using agent terminal 301) to a server 303 over a network 302 (which may be a wired network or a wireless network). Server 303 may be, or may include one or more of, computing device 100 as shown in FIG. 1. Server 303 may include, or may be connected to, a Schedule Request Manager (SRM) 340, a Schedule Manager (SM) 350, a Schedule Database (DB) 360, and/or a trade request database (DB) 370. Schedule Request Manager 340 may be a microservice, and may be connected to a Schedule Manager (SM) 350, which may be a microservice. SRM 340 may receive the parameters/preferences of the trade request once agent terminal 301 has sent these data to server 303. SM 350 may fetch schedules and trade configuration(s) from a Schedule Database (DB) 360, and may send the schedules and trade configuration(s) to SRM 340. The schedules may be those which belong to a set of target agents associated with a corresponding set of shift parameters that satisfy the set of preferences of the multi-day trade request initiated by source agent 310 using agent terminal 301.

SRM 340 may present a list of target agents to source agent 310 via user interface 330. Source agent 310 may review the list of target agents and submit a target agent selection (which may be a multiple selection) via user interface 330.

User interface 330 may receive the target agent selection made by source agent 310 and may send this to SRM 340, which may process the selection to generate a multi-day trade submission for sending to a trade request database (DB) 370.

In FIG. 3B, a target agent 320 accepts the multi-day trade request. Target agent 320 may be a target agent from the selection made by source agent 310 in FIG. 3A, or may be a different target agent: for example an identified target agent with shift parameters matching the source agent's preferences, but who was not initially selected by source agent 310, but who has since been sent a trade request because (potentially automatically) because the first trade request was rejected.

Target agent 320 may accept the multi-day trade request using user interface 330, which may send indication of trade acceptance to SRM 340 for approval. SRM 340 may apply approval criteria to approve the accepted trade request so that it may proceed, for example by checking that a skill of source agent 310 matches a skill of target agent 320, and/or a check that a scheduling unit of source agent 310 matches a scheduling unit of target agent 320. Such checks may be made by SRM 340 against data stored in schedule database 360. Schedule manager 350 may fetch schedules and trade configurations from schedule database 350 and send these to SRM 340.

SRM 340 may fetch a trade request status from trade request database 370. The trade request status may relate to whether a trade request has already been accepted, approved, and closed. For example, a different target agent of the sub-set of selections may have already accepted the request.

If the trade request status is open (e.g. it has not been closed due to having already been accepted and processed), then SRM 340 may process the trade request by updating the trade request as accepted and approved. SRM 340 may operate with Schedule manager 350 to update or otherwise adjust the agent schedules (e.g. the schedule of source agent 310 and target agent 320) to reflect the trade.

SRM 340 may indicate to user interface 330 that the trade was successful, and user interface 330 may show a success message to target agent 320 and source agent 310.

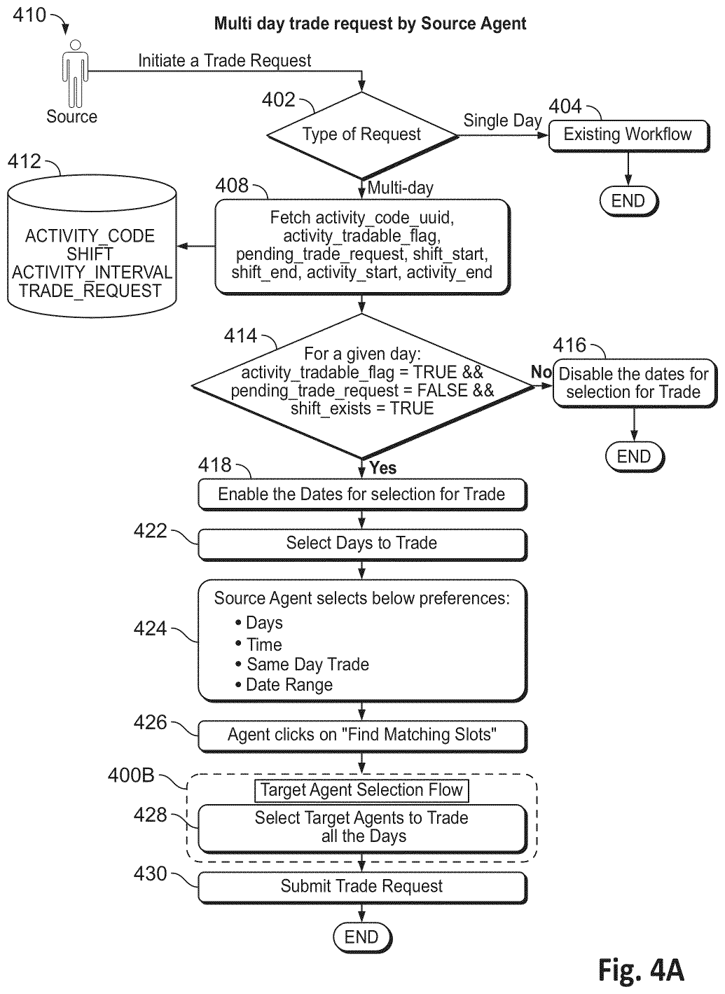

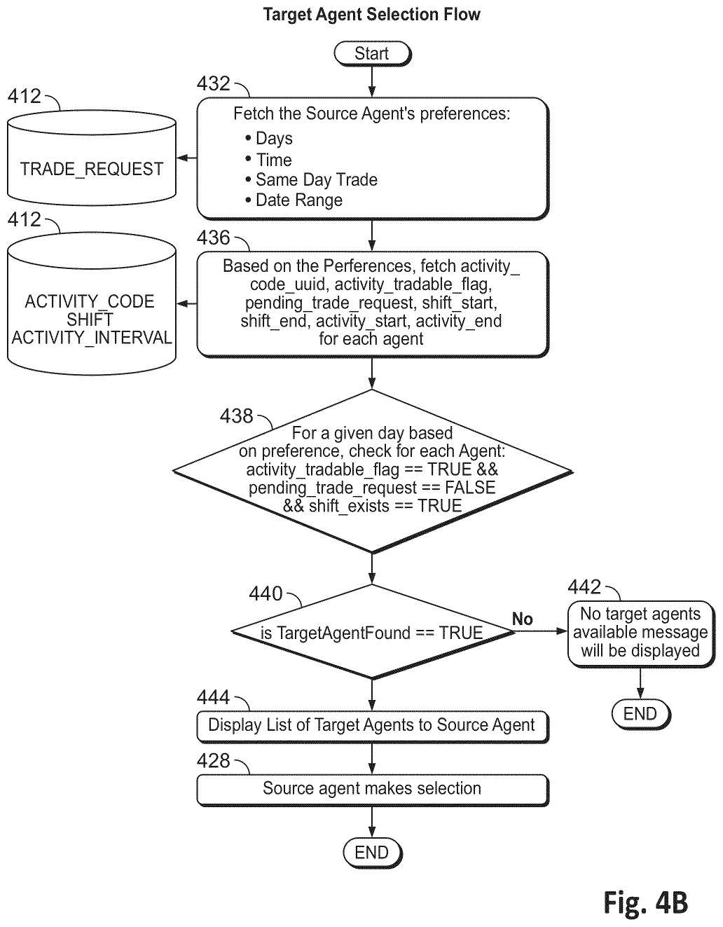

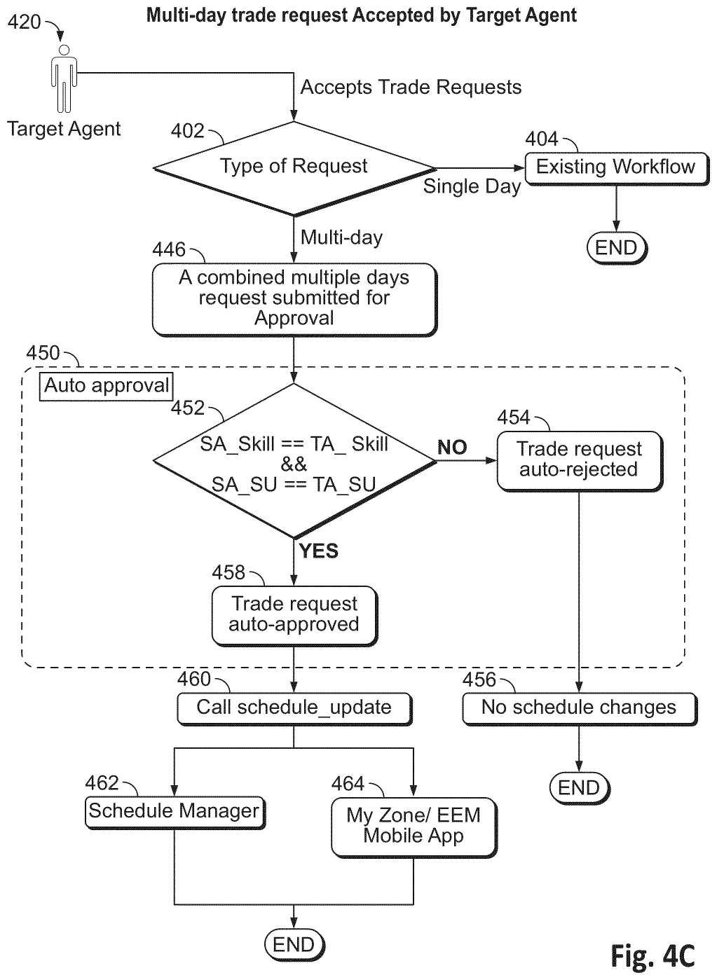

FIG. 4A shows an example flow according to embodiments of the invention. A source agent 410 may initiate a trade request (for example using a user interface 330 presented by agent terminal 301 as described in FIG. 3A). Embodiments of the invention may determine the type of request as a decision step 402, for example based on a selection by source agent 410. If the type of request is a single day request (for example a single shift traded for a shift on a different day), then an existing workflow of a WFM application may be used at step 404.

If the type of request determined at 402 is a multi-day request (for example more than one shift traded for different shifts on the same or different days, or a single shift traded for a shift on the same day) then embodiments of the invention may identify the days which can be traded by source agent 410. For this, and as shown at step 408, example data such as activity_code_uuid, activity_tradeable_flag, pending_trade_request, shift_start, shift_end, activity_start and activity_end data may be fetched from a datastore 412, shown in FIG. 4A as containing ACTIVITY_CODE, SHIFT, ACTIVITY_INTERVAL, and TRADE_REQUEST via a Schedule Manager microservice (such as schedule manage MS 350 shown in FIG. 3A). As will be known to one skilled in the art, a UUID, universally unique identifier, may be a 128-bit number used to uniquely identify information in computer systems and databases. UUIDs are typically represented as a string of 32 hexadecimal digits separated by hyphens, and are typically designed to be globally unique. As used herein, “activity_code_uuid” may be a UUID identifier that corresponds to a particular activity. This identifier may be used to distinguish different types of activities, such as “Open,” “Meeting.” “Break,” “Lunch,” or any other activities. When dealing with shifts and activities, a UUID can allow each activity to have a unique identifier and may help prevent conflicts when handling and managing activities in the system. The UUID can be used to check if a specific shift activity is tradable or not, which may make it easier to track and manage shift-related information in a reliable and distinct way. Other data/parameter/variable/function names may be used.

To enable the days to the selected to be traded, validation criteria may be used by embodiments of the invention. For example, one or more possible date values of the multi-day trade request may be restricted for selection based on an assessment of the schedule of source agent 410 against a set of validation criteria. The validation criteria may include, for a given date, a check (e.g. at step 414) that: source agent 410 has a shift on the given date; a pending multi-day trade request does not include the given date; and/or the given date includes a shift with a tradeable activity.

For example, if a shift is present on a given day (based on, for example, shift_start and shift_end), then a shift_exists value may be evaluated as TRUE, e.g. shift_exists=TRUE.

As another example, embodiments may require that there should not be an existing trade request present on the given day (e.g. pending_trade_request=FALSE). For example, if an agent has already requested trade for the same date, then they may not be permitted to trade a shift on that given day.

As another example, the shift should contain activities which should be tradeable (e.g. based on activity_code_uuid, activity_start and activity_end, then activity_tradeable_flag=TRUE). Whether a shift activity is tradeable may be predefined or set by a manager to indicate (e.g. to flag) that the activity can be carried out by a different agent. For example, when a shift contains a non-tradable activity, embodiments of the invention an agent may not be permitted to trade the shift.

In some embodiments, all (e.g. a logical AND, &&) of the validation criteria must be satisfied, for example the check at 414 for the given day requires: activity_tradable_flag=TRUE && pending_trade_request=FALSE && shift_exists=TRUE.

For example, if any of the validations fails, the given day will not be enabled for selection for the trade request (for example it may be “greyed out”). The disabling of such dates for selection is shown at step 416 of FIG. 4A.

If all the validation criteria at step 414 are successful (e.g. matched/satisfied), then the dates will be enabled to trade in the user interface (e.g. user interface 330 shown in FIG. 3A) as shown by step 418, and source agent 410 can select any of those dates to trade, as shown by step 422.

Source agent 410 can select their shift trade preferences against which they want to trade their shift, as shown by step 424. These may include: Days of the week; time in which the shift lies; whether the agent wants to trade the shift on the same day but a different time; the date range in which the agent wants the shift to be traded, or the like.

On submitting the preferences, for example by clicking on a user interface element labelled “Find Matching Slots” or the like, as shown at step 426, embodiments may identify a set of target agents with whom source agent 410 can trade their shift(s), and may display these through the user interface (such as user interface 330 displayed by agent terminal 301 shown in FIG. 3A). Details of the logic for selecting target agents as employed by embodiments of the invention are shown in FIG. 4B, the process of which is labelled as 400B in FIG. 4A.

Source agent 410 may select a sub-set (which may be, for example, the entire set of identified target agents) of the target identified set of target agents to trade all of their selected shifts, as shown at step 428.

Source agent 410 may submit the trade request, as shown at step, 430, and the flow as shown by FIG. 3A may end.

FIG. 4B shows an example flow according to embodiments of the invention. As described with reference to FIG. 4A and sub-flow 400B therein, Details of the logic for selecting target agents as employed by embodiments of the invention are shown in FIG. 4B.

To get the list/set of target agents, embodiments may fetch source agent 410's preferences from the TRADE_REQUEST datastore (412) which is part of the SRM microservice (e.g. see FIG. 3A), as shown by step 432.

Embodiments may also fetch (e.g. as shown by step 436) activity_code_uuid, activity_tradeable_flag, pending_trade_request, shift_start, shift_end, activity_start and activity_end from the datastore ACTIVITY_CODE, SHIFT, ACTIVITY_INTERVAL datastores (412) for target agents within the day/date and time range as specified in the source agent's preferences, e.g. based on the set of preferences, target agents associated with shift parameters satisfying the set of preferences are identified.

Embodiments of the invention may use a decision process (e.g. as shown at step 438) to check, for a given day and based on the set of source agent preferences, that the target agent shift on the given day satisfies the validation criteria. For example, embodiments of the invention may check that activity_tradable_flag==TRUE && pending_trade_request==FALSE && shift_exists==TRUE, e.g. using a logical match operator==.

If no target agents have shifts matching both the source agent's preferences and the validation criteria, for example isTargetAgentFound==FALSE at step 440, then embodiments of the invention may display a message to source agent 410, for example using user interface 330 displayed on an agent terminal 301, that no target agents are available. The flow may then end. The source agent can modify their preferences to enable the process flow of FIGS. 4A and 4B again, which they may be prompted to do so by an in-system message on user interface 330.

If the validation criteria at step 438 are satisfied for at least one target agent and their respective shifts, (e.g. isTargetAgentFound==TRUE at step 440), then embodiments of the invention may list this set of target agents and display them to source agent 410 via user interface 330 displayed on an agent terminal 301, as shown at step 444. Source agent 410 can then select a sub-set of one or more of the identified target agents with whom to request to trade their shift, as shown at step 428 of FIG. 4B and FIG. 4A.

Upon submitting the trade request source agent 410, one or more target agents 420 as selected by source agent 410 may receive the request, for example a sub-set of target agents of the identified set from which the source agent made their selections.

When the first target agent accepts the request, the trade request for the remaining target agents may be set to inactive, for example as being marked as closed. For example, a first target agent of the sub-set to accept the multi-day trade request prevents other target agents of the sub-set from accepting the request.

FIG. 4C shows an example flow according to some embodiments of the invention. The example flow shows how embodiments of the invention can automatically approve and automatically adjust the schedules of the agents once a target agent accepts the trade request.

Embodiments of the invention may identify the type of request at step 402, as in FIG. 4A. If the request is a single day request, the workflow may remain the same as is currently implemented in the existing WFM application, as shown by step 404.

If the type of request is a multi-day request, the request for all the days will be sent by embodiments of the invention as a single combined request for approval, as shown at step 446.

Embodiments of the invention can automate the approval process such that shift trading will not impact on the contact center's staffing condition (whilst described in the context of agents in a call center, embodiments of the invention are applicable to other contexts requiring digital scheduling). An auto-approval sub-flow, according to embodiments of the invention and labelled 450 in FIG. 4C may include checks against a pre-defined set of approval criteria, for example as shown at step 452.

Embodiments of the invention may check that SA_Skill==TA_Skill && SA_SU==TA_SU, for example that a skill of the source agent (SA) and target agent (TA) match, and that a scheduling unit (SU) of the source agent and target agent match.

If these conditions are not met, the trade request may be automatically rejected, as shown at step 454. In such circumstances, there will not be any adjustment of the agents' schedules, as shown at step 456, and the flow may end. The source agent may receive an in-system message, e.g. via the user interface, that the trade was not successful, and may be prompted to select new target agents, for example if there were available target agents which were not previously selected. In some embodiments, upon a trade request being rejected in respect of a given target agent, a closed status of the request (e.g. closed so as to prevent other agents accepting once a first agent has already accepted) may be changed to “open”, such that the source agent's original selection of target agents may be reused and allow a new target agent of the sub-set to accept the request.

If the approval criteria at step 452 are satisfied, then the trade request may be auto-approved as shown at step 458, and the schedules of both the source agent and the target agent may be updated to reflect the traded shifts, as shown at step 460. A function such as schedule_update may be called by embodiments of the invention to implement the adjusting of the schedules, for example so that changes to the schedules are reflected in the schedule manager microservice (e.g. in schedule database 360 shown in FIGS. 3A and 3B) and the user interface (e.g. My Zone and/or an Employee Engagement Manager “EEM” mobile application). The flow may then end, with the trade request having been successfully implemented.

Embodiments of the invention may not require a human manager to approve requests, and thus overhead can be reduced, and efficiency improved. Embodiments may also collect and batch the requests as a multi-day request, rather than the typical single day requests of existing WFM applications, thereby reducing system traffic and reducing use of computer resources and power.

Embodiments of the invention may use the example data structures (e.g. pseudo-code) described in Table 1. Other data structures and naming conventions may be used.

TABLE 1

| Data Structure | Explanation |
|---|---|
| ENUM | May be an enumeration which can |
| Trade_Request_Type{SINGLE, | have Single & Multi_day as possible |
| MULTI_DAY} | values. These values may be used |
| | to determine the request type, |
| | when submitting a trade request and |
| | when finding the set of target agents. |
| UUID | May be a universally |
| activity_code_uuid | unique identifier “UUID |
| | “which corresponds to a particular |
| | activity (e.g. Open, Meeting, |
| | Break, Lunch etc.). This |
| | identifier may be used when checking |
| | if a shift activity is tradable or not. |
| Boolean | Every activity may have a |
| activity_tradeable_flag | configuration mentioned which |
| | will stay TRUE if that activity |
| | is allowed to be tradable by the |
| | agents or it will stay as FALSE in |
| | case it is configured as non-tradable. |
| Boolean | This flag may represent whether |
| pending_trade_request | the source agent has already |
| | requested for any trades which |
| | conflict with the activity_start & |
| | activity_end time. If there is |
| | a conflict this flag can be set to |
| | TRUE, else it will be set to FALSE. |
| LocalDateTime | This denotes the whole shift |
| shift_start | start time of the agent |
| | (source or target). |
| LocalDateTime | This denotes the whole shift |
| shift_end | end time of the agent |
| | (source or target). |
| LocalDateTime | This denotes an activity |
| activity_start | start time of the agent |
| | (source or target). |
| LocalDateTime | This denotes activity end |
| activity_end | time of the agent |
| | (source or target). |
| UUID | This represents the unique |
| skill | skill identifier for the |
| | agent (source or target). |
| UUID | This represents the unique |
| scheduling_unit | identifier of the scheduling |
| | unit to which an agent |
| | (source or target) belongs. |

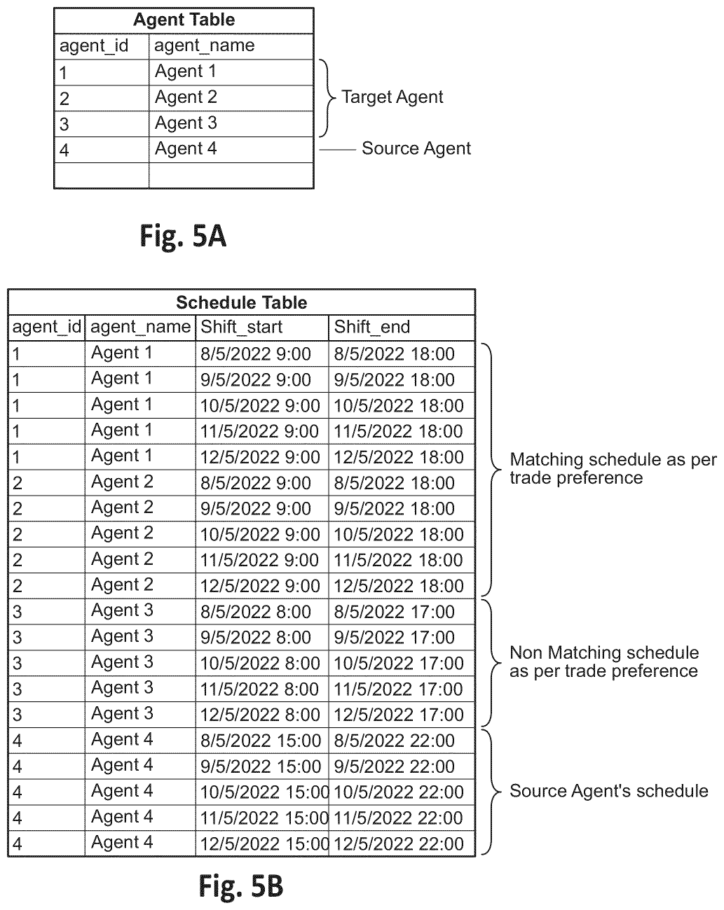

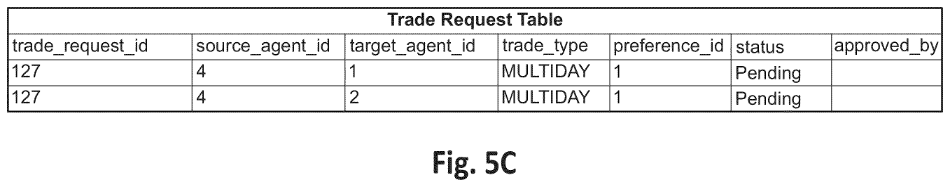

FIGS. 5A, 5B, and 5C show example results of simulations, according to some embodiments of the invention.

The example considers four agents. FIG. 5A shows all of the available agents, Agent 1, Agent 2, Agent 3, Agent 4, and their associated unique agent_id, with Agent 4 being the source agent for this example.

FIG. 5B shows a schedule table, containing the schedules of all four agents from May 8, 2022, to May 12, 2022. Agent 4's schedule (the source agent) falls in the second shift, from 3 pm to 10 pm.

The fields “shift_start” and “shift_end” in the schedule table serve as the reference points for the agents' schedules, allowing for the matching of shift parameters in the schedule table against the source agent's trade preferences, thus enabling the retrieval of the corresponding schedule.

The shift preferences selected by Agent 4 on a user interface can be used to retrieve data from the schedule table. The matching schedules and their agents will be fetched from the schedule table based on the preference data selected by Agent 4 as the source agent.

In this example, Agent 4 has selected a shift preference of 9 am to 6 pm. FIG. 5B shows the schedules of Agents 1 and 2 as matching/satisfying the selected preference and shows the schedule of Agent 3 as not matching/satisfying the selected preference. The source agent's schedule, agent 4, is also shown.

Once an agent's schedule has been identified as matching/satisfying the source agent's preference(s), the matching agent's details can be retrieved, and a trade request can be sent to them. The trade request may be assigned a unique id and may be stored in a trade request table or other data format with example fields as shown in FIG. 5C. A status of the request may be marked as pending until the request is accepted by one of the recipient target agents.

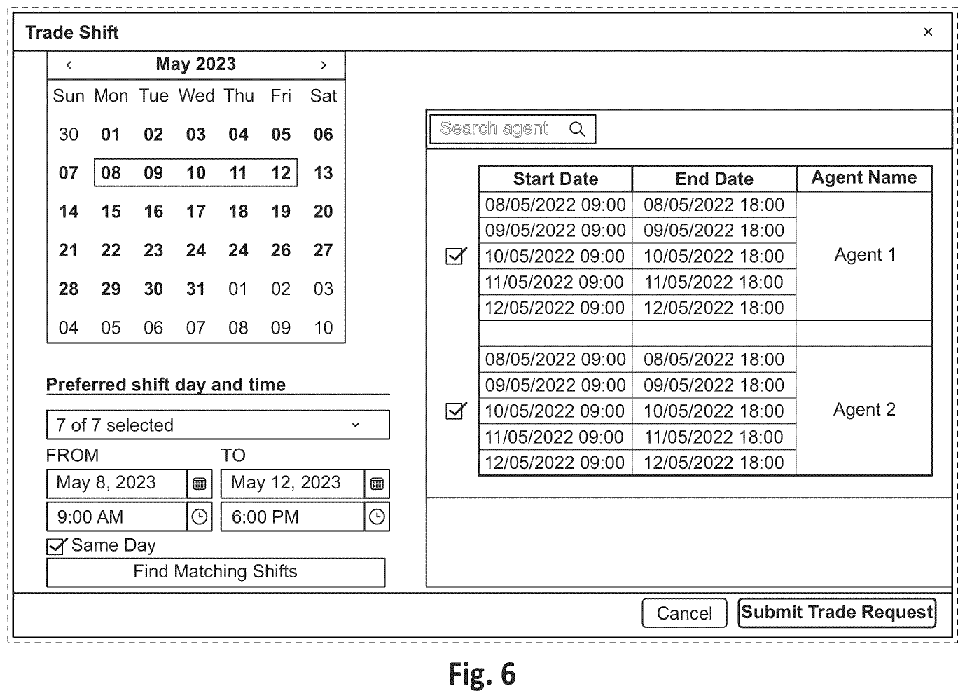

FIG. 6 shows an example user interface, according to some embodiments of the invention.

The user interface may be displayed by an agent terminal, such as agent terminal 301 shown in FIGS. 3A and 3B. An agent can select the days they want to trade from the calendar menu. Some days may be greyed out and unable to be selected, for example because embodiments of the invention have indicated that those days do not contain a shift, do not contain a tradable activity, and/or are already subject to a pending trade request.

Under the Preferred shift day and time section, the agent can select the days, date, and the time range during which they want their shift to be swapped with. These selections may be selected as part of the shift trade references.

The checkbox “Same Day” can allow an agent to trade their shifts with shifts of other agents on the same day but a different time.

Upon selecting the “Find Matching Shifts” button, a list/set of target agents that have shifts satisfying the shift trade preferences along with the corresponding shift details (e.g. the date and time) may be displayed. The source agent can find suitable matches and can submit the trade request for acceptance to multiple target agents.

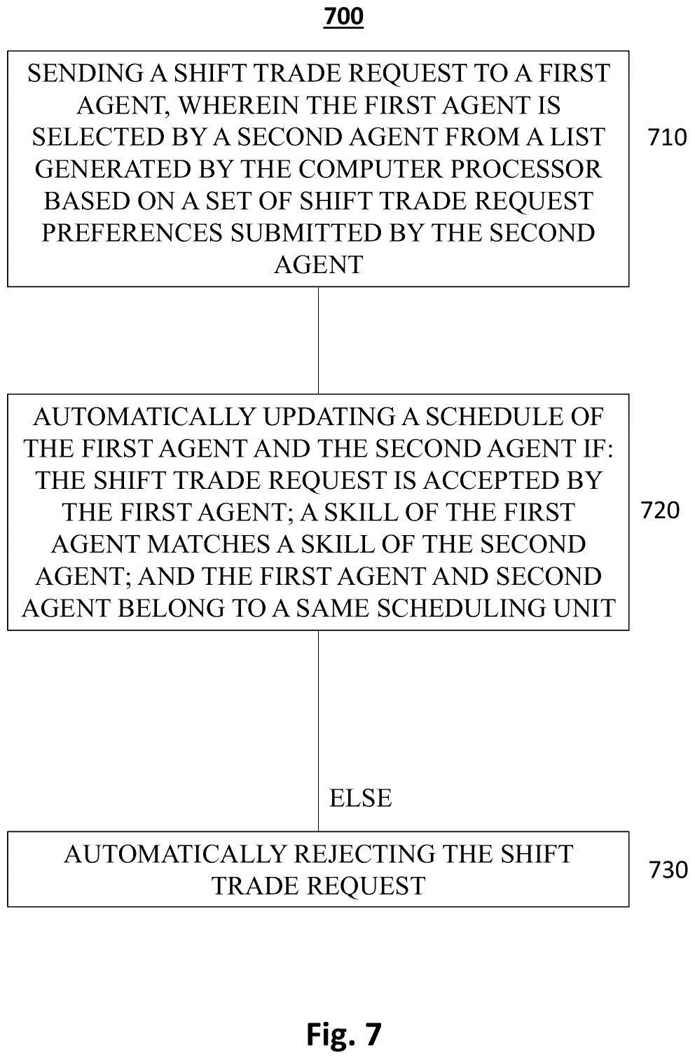

FIG. 7 shows a flowchart of a method, according to embodiments of the invention.

The method 700 may be a method for scheduling, and may include using a computer processor (such as or in included as part of computing device 100 shown in FIG. 1): sending a shift trade request to a first agent, wherein the first agent is selected by a second agent from a list generated by the computer processor based on a set of shift trade request preferences submitted by the second agent (Step 710).

Method 700 may further include automatically updating a schedule of the first agent and the second agent if: the shift trade request is accepted by the first agent; a skill of the first agent matches a skill of the second agent; and the first agent and second agent belong to a same scheduling unit (Step 720).

Else, method 700 may include automatically rejecting the shift trade request (Step 730).

As part of method 700, the set of shift trade request preferences may include a shift day preference and a shift time preference, as described herein. The shift trade request may include a plurality of shift days, for example non-consecutive shift days.

Method 700 may include, if the shift trade request accepted by the first agent is automatically rejected due to a skill of the first agent not matching a skill of the second agent, or due to the first agent and second agent not belonging to the same scheduling unit (e.g. failing to satisfy the approval criteria), then automatically re-sending the shift trade request to one or more other agents on the list generated by the computer processor.

The present invention may be embodied as a non-transitory computer readable storage medium containing instruction which, when executed by at least one processor in a computing device (such as computing device 100 of FIG. 1), cause the at least one processor to carry out methods as described herein.

The present invention may also be embodied as a system, for example a system which includes at least one processor; and a computer readable storage medium containing instructions which, when executed by the at least one processor, cause the at least one processor to carry out one or more methods described herein.

For example, embodiments of the invention may be carried out by a computing device as shown in FIG. 1, integrated into an existing WFM architecture, or operating a new WFM architecture. The at least one processor may: identify a set of target agents associated with a corresponding set of shift parameters that satisfy a set of preferences of a multi-day trade request initiated by a source agent; send the multi-day trade request to a sub-set of the identified target agents selected by the source agent; and if a first target agent of the sub-set accepts the multi-day trade request, and if the multi-day trade request satisfies a pre-defined set of approval criteria, then automatically approve the multi-day trade request between the source agent and said first target agent of the sub-set to accept the multi-day trade request, and automatically adjust a schedule of the source agent and the first target agent to reflect the approved multi-day trade request; else: automatically reject the multi-day trade request.

Embodiments of the invention may thus improve WFM technologies and reduce system traffic by combining multiple single day trade requests into a multi-day request.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A computer implemented method for digital scheduling comprising, using a processor:
identifying a set of target agents associated with a corresponding set of shift parameters that satisfy a set of preferences of a multi-day trade request initiated by a source agent;
sending the multi-day trade request to a sub-set of the identified target agents selected by the source agent; and
if a first target agent of the sub-set accepts the multi-day trade request, and if the multi-day trade request satisfies a pre-defined set of approval criteria, then automatically approving the multi-day trade request between the source agent and said first target agent, and automatically adjusting a schedule of the source agent and the first target agent to reflect the approved multi-day trade request; else:
automatically rejecting the multi-day trade request.

2. The method of claim 1, wherein the set of preferences of the multi-day trade request comprises at least one of: a date range preference, a time range preference, and a same-day trade preference.

3. The method of claim 1, wherein one or more possible date values of the multi-day trade request are restricted upon initiation of the multi-day trade request based on an assessment of the schedule of the source agent against a set of validation criteria.

4. The method of claim 3, wherein the validation criteria for a given date comprises a check that:
the source agent has a shift on the given date;
a pending multi-day trade request does not include the given date; and
the given date includes a shift with a tradeable activity.

5. The method of claim 1, wherein the approval criteria comprises: a check that a skill of the source agent matches a skill of the target agent, and a check that a scheduling unit of the source agent matches a scheduling unit of the target agent.

6. The method of claim 1, wherein the multi-day trade request comprises a single day with a shift trade request which overlaps with an existing shift of the source agent.

7. The method of claim 1, wherein the multi-day trade request relates to two or more non-consecutive days.

8. The method of claim 1, wherein if the multi-day trade request accepted by the first target agent of the sub-set is automatically rejected due to not satisfying the pre-defined set of approval criteria, then automatically re-sending the multi-day trade request to the remaining target agents of the sub-set.

9. A method for scheduling, the method comprising, using a computer processor:
sending a shift trade request to a first agent, wherein the first agent is selected by a second agent from a list generated by the computer processor based on a set of shift trade request preferences submitted by the second agent; and
automatically updating a schedule of the first agent and the second agent if:
the shift trade request is accepted by the first agent;
a skill of the first agent matches a skill of the second agent; and
the first agent and second agent belong to a same scheduling unit;
else:
automatically rejecting the shift trade request.

10. The method of claim 9, wherein the set of shift trade request preferences comprises a shift day preference and a shift time preference.

11. The method of claim 10, wherein the shift trade request includes a plurality of shift days.

12. The method of claim 9, wherein if the shift trade request accepted by the first agent is automatically rejected due to a skill of the first agent not matching a skill of the second agent, or due to the first agent and second agent not belonging to the same scheduling unit, then automatically re-sending the shift trade request to one or more other agents on the list generated by the computer processor.

13. A system for digital scheduling, the system comprising:
at least one processor; and
a computer readable storage medium containing instruction which, when executed by the at least one processor, cause the at least one processor to:
identify a set of target agents associated with a corresponding set of shift parameters that satisfy a set of preferences of a multi-day trade request initiated by a source agent;
send the multi-day trade request to a sub-set of the identified target agents selected by the source agent; and wherein
if a first target agent of the sub-set accepts the multi-day trade request, and if the multi-day trade request satisfies a pre-defined set of approval criteria, then automatically approve the multi-day trade request between the source agent and said first target agent of the sub-set to accept the multi-day trade request, and automatically adjust a schedule of the source agent and the first target agent to reflect the approved multi-day trade request; else:
automatically reject the multi-day trade request.

14. The system of claim 13, wherein the set of preferences of the multi-day trade request comprises at least one of: a date range preference, a time range preference, and a same-day trade preference.

15. The system of claim 13, wherein the at least one processor is configured to restrict one or more possible date values of the multi-day trade request upon initiation of the multi-day trade request based on an assessment by the at least one processor of the schedule of the source agent against a set of validation criteria.

16. The system of claim 15, wherein the validation criteria for a given date comprises a check that:
the source agent has a shift on the given date;
a pending multi-day trade request does not include the given date; and
the given date includes a shift with a tradeable activity.

17. The system of claim 13, wherein the approval criteria comprises: a check by the at least one processor that a skill of the source agent matches a skill of the target agent, and a check by the at least one processor that a scheduling unit of the source agent matches a scheduling unit of the target agent.

18. The system of claim 13, wherein the multi-day trade request comprises a single day with a shift trade request which overlaps with an existing shift of the source agent.

19. The system of claim 13, wherein the multi-day trade request relates to two or more non-consecutive days.

20. The system of claim 13, wherein the at least one processor is configured to, if the multi-day trade request accepted by the first target agent of the sub-set is automatically rejected due to not satisfying the pre-defined set of approval criteria, automatically re-send the multi-day trade request to the remaining target agents of the sub-set.
